(19) United States
(12) Patent Application Publication
(10) Pub. No.: US 2026/0021499 A1
(43) Pub. Date: Jan. 22, 2026

(54) SPRINKLER HEAD NOZZLE ASSEMBLY WITH NOZZLE GUARD

(71) Applicant: K-Rain Manufacturing Corp., Riviera Beach, FL (US)

(72) Inventor: Carl L.C. Kah, III, North Palm Beach, FL (US)

(21) Appl. No.: 18/778,526

(22) Filed: Jul. 19, 2024

(51) Int. Cl. B05B 1/26; B05B 15/16; B05B 15/40

(52) U.S. Cl. CPC B05B 1/262; B05B 15/16; B05B 15/40

(57) ABSTRACT

A sprinkler head nozzle assembly including a movable nozzle guard movable to selectively cover and uncover a nozzle to prevent debris from entering the assembly.

### BACKGROUND

### Field

The present application relates to a sprinkler including a movable nozzle guard that moves from a closed position in which it covers a nozzle of the sprinkler to prevent entry of debris to an open position in which it is separated from the nozzle to allow water exit the sprinkler via the nozzle.

Conventional sprinkler assemblies, whether rotary or oscillating, share a common problem in that nozzle openings in these conventional sprinklers are exposed to the environment during operation such that debris may enter the nozzle and damage the sprinkler. When debris enter the nozzle, it may interfere with water flow within the sprinkler and/or out of the nozzle. In addition, debris may damage or limit performance of the interior of the sprinkler.

Accordingly, it would be beneficial to provide a sprinkler that avoids the above and other problems.

### SUMMARY

A sprinkler head nozzle assembly in accordance with an embodiment of the present disclosure includes a nozzle guard movable from a closed position where the nozzle guard covers a nozzle to prevent debris from entering the nozzle and an open position to allow water to flow out of the sprinkler assembly.

A sprinkler head nozzle assembly in accordance with an embodiment of the present disclosure includes: a body including at least a first opening configured to allow water to pass therethrough; a flow control element mounted in the body to control a flow of water through the sprinkler head nozzle assembly; a flow director positioned downstream of the flow control element, the flow director including at least one angled opening configured to direct water upward in a helical pattern; a deflector positioned downstream of the flow director and including a central opening configured to direct water out of the sprinkler head nozzle assembly; and a nozzle cover positioned downstream of the deflector and movable from a closed position in which it covers the central opening and an open position in which it is spaced from the central opening such that water passes out of the central opening.

In embodiments, the sprinkler head nozzle assembly includes a rod, movably mounted in the sprinkler head nozzle assembly, wherein the nozzle guard is attached to a top of the rod such that the rod moves the nozzle guard from the closed position to the open position.

In embodiments, the sprinkler head nozzle assembly includes a movable element mounted in the sprinkler head, wherein the movable element is biased in a lowered position and movable to a raised position, wherein the movable element is operably connected to the rod to move the rod from the closed position to the open position.

In embodiments, the rod includes a ridge extending radially outward around the rod at a bottom thereof, wherein the ridge engages the movable element such that the rod moves up and down in the sprinkler head nozzle assembly with the movable element.

In embodiments, the sprinkler head nozzle assembly includes a filter provided upstream from the body and configured to provide water to the body.

In embodiments, the flow control element includes at least a second opening and the flow control element is movable relative to the body to move at least the second opening into and out of alignment with at least the first opening to control flow of water.

In embodiments, the body includes a plurality of first openings configured to allow water to pass through the body.

In embodiments, the flow control element includes a plurality of second openings, wherein the flow control element is movable relative to the body to move the plurality of second openings into and out of alignment with the plurality of first openings to control flow of water.

In embodiments, the flow director includes a plurality of angled openings configured to direct water upward in a helical pattern.

In embodiments, a periphery of the central opening of the deflector includes a beveled edge configured to direct water out of the sprinkler head nozzle assembly.

A sprinkler head nozzle assembly in accordance with another embodiment of the present disclosure includes: a body including at least a first opening configured to allow water from the filter to pass therethrough; a flow control element mounted in the body to control a flow of water through the sprinkler head nozzle assembly; a nozzle cover positioned downstream of the flow control element and including: a bottom portion including a deflector surface configured to direct water out a side of the sprinkler head nozzle assembly; and a top portion movable relative to the bottom portion from a lowered position in which the top portion prevents debris from entering and a raised position in which water exits the sprinkler head nozzle assembly.

In embodiments, the sprinkler head nozzle assembly includes a rod, movably mounted in the sprinkler head nozzle assembly, wherein the nozzle guard is attached to a top of the rod such that the rod moves the nozzle guard from the lowered position to the raised position.

In embodiments, the sprinkler head nozzle assembly includes a movable element mounted in the sprinkler head nozzle assembly, wherein the movable element is biased in a lowered position and movable to a raised position, wherein the movable element is operably connected to the rod to move the rod from the lower position to the raised position.

In embodiments, the rod includes a ridge extending radially outward around the rod at a bottom thereof, wherein the ridge engages the movable element such that the rod moves up and down in the sprinkler head nozzle assembly with the movable element.

In embodiments, the sprinkler head nozzle assembly includes a filter provided upstream from the body and configured to provide water to the body.

In embodiments, the flow control element includes at least a second opening and the flow control element is movable relative to the body to move at least the second opening into and out of alignment with at least the first opening to control flow of water.

In embodiments, the body includes a plurality of first openings configured to allow water to pass through the body.

In embodiments, the flow control element includes a plurality of second openings, wherein the flow control element is movable relative to the body to move the plurality of second openings into and out of alignment with the plurality of first openings to control flow of water.

In embodiments, the lower portion includes a plurality of blocking tabs configured to partially block water flow.

### BRIEF DESCRIPTION OF THE DRAWINGS

FIG. 1 illustrates a cross-sectional view of a sprinkler head nozzle assembly in accordant with an embodiment of the present disclosure;

FIG. 2 illustrates a cross-sectional view of the sprinkler head nozzle assembly of FIG. 1 mounted on a sprinkler body in accordant with an embodiment of the present disclosure;

FIG. 3 illustrates a cross-sectional view of the sprinkler head nozzle assembly of FIG. 1 with a nozzle guard in a raised position to allow water spray from the nozzle in accordant with an embodiment of the present disclosure;

FIG. 4 illustrates a bottom view of the nozzle guard of the sprinkler head nozzle assembly of FIG. 1 in accordance with an embodiment of the present disclosure;

FIG. 5 illustrates a bottom view of a deflector of the sprinkler head nozzle assembly of FIG. 1 in accordant with an embodiment of the present disclosure;

FIG. 6 illustrates a top view of a flow director element of the sprinkler head nozzle assembly of FIG. 1 in accordant with an embodiment of the present disclosure;

FIG. 7 illustrates a detailed view of a base of the sprinkler head nozzle assembly of FIG. 1 in accordant with an embodiment of the present disclosure;

FIG. 8 illustrates a detailed view of a flow control element of the sprinkler head nozzle assembly of FIG. 1 in accordant with an embodiment of the present disclosure;

FIG. 9 illustrates a detailed view of a body of the sprinkler head nozzle assembly of FIG. 1 in accordant with an embodiment of the present disclosure;

FIG. 10 illustrates the flow control element of FIG. 8 mounted in the body of FIG. 9 and in an open position in accordant with an embodiment of the present disclosure;

FIG. 11 illustrates the flow control element of FIG. 8 mounted in the body of FIG. 9 and in a closed position in accordant with an embodiment of the present disclosure;

FIG. 12 illustrates a cross-sectional view of a sprinkler head nozzle assembly in accordant with another embodiment of the present disclosure;

FIG. 13 illustrates a cross-sectional view of the sprinkler head nozzle assembly of FIG. 12 with a nozzle guard in a raised position to allow water to spray from the nozzle in accordance with an embodiment of the present disclosure;

FIG. 14 illustrates a bottom view of the nozzle guard of sprinkler head nozzle assembly of FIG. 12 in accordance with an embodiment of the present disclosure;

FIG. 15 illustrates a bottom view of a deflector of the sprinkler head nozzle assembly of FIG. 12 in accordance with an embodiment of the present disclosure.

### DESCRIPTION OF THE EMBODIMENTS

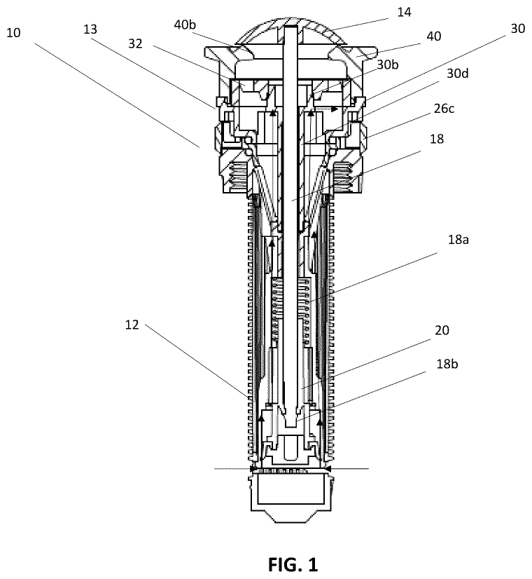

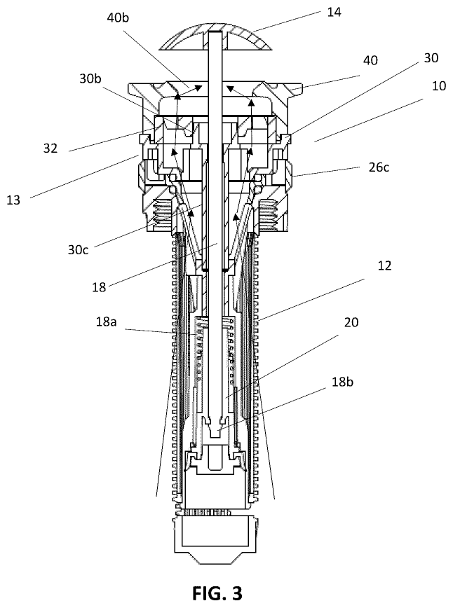

A sprinkler head nozzle assembly 10 in accordance with an embodiment of the present disclosure is illustrated in FIG. 1. In embodiments, the sprinkler head nozzle assembly 10 includes a lower filter element 12 through which water may flow to the nozzle head 13. In embodiments, the nozzle guard 14 may be mounted on top of the nozzle head 13. In embodiments, the nozzle guard 14 is mounted on a rod 18 that is movably mounted in the assembly 10 between a closed position shown in FIG. 1, where the nozzle guard 14 covers and protects the nozzle and prevents debris from entering. FIG. 4 shows a bottom view of the nozzle guard 14. The rod 18 is biased into the closed position (FIG. 1) using the biasing element 18a, which may be a spring or any other suitable biasing element. In embodiments, a distal end of the rod 18 may include a ridge 18b that extends radially outward around the rod to engage a movable member 20 that is biased into the closed position via the biasing element 18a. As water passes into the filter 12, water pressure pushes up on the movable member 20 and pushes it upward against the biasing force of the biasing element 18a to raise the nozzle guard 14 away from a top deflector 40 of the assembly 10 as indicated in FIG. 3, for example.

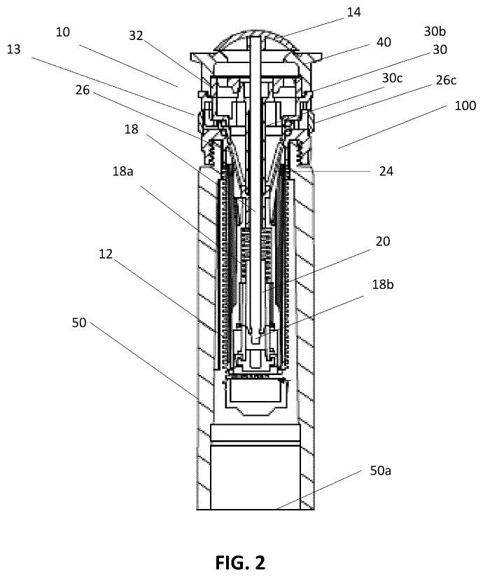

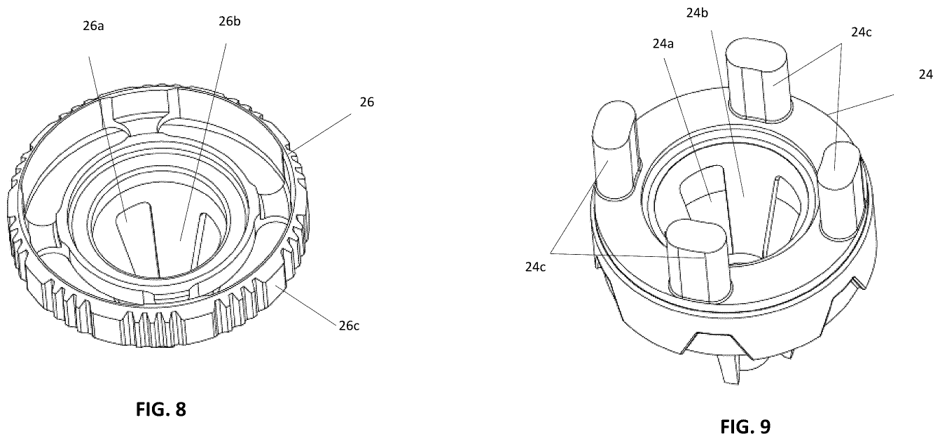

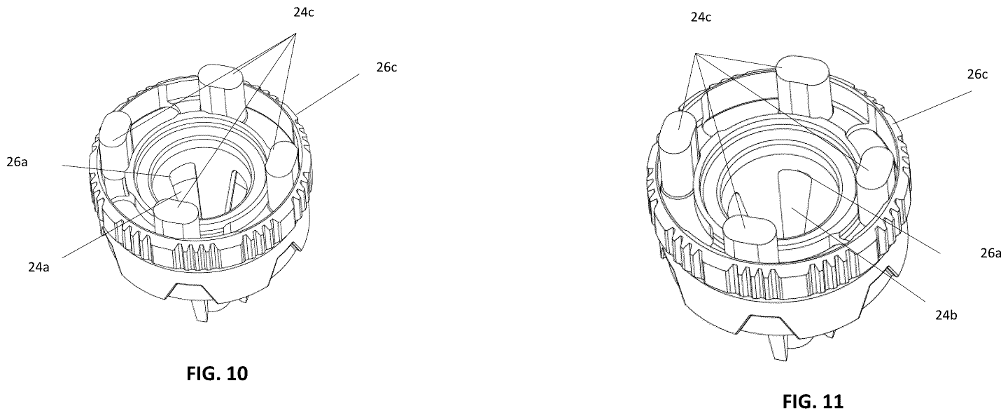

In FIG. 2, the sprinkler head nozzle assembly 10 is mounted in a sprinkler body 50. In embodiments, the sprinkler body 50 may include an inlet 50a connected to a water supply. In embodiments, water flows into the sprinkler body 50 and through the sprinkler head nozzle assembly 10 as indicated by the arrows in FIG. 3. In embodiments, water flows into filter 12 to a body 24 of the sprinkler head nozzle assembly 10. The water pressure caused by the water passing through the filter pushed the movable element 20 upward. In embodiments, the body 24 is conical in shape with the rod 18 extending through center thereof. A plurality of openings 24a are provided between a plurality of body ribs 24b in the body 24 such that the openings allowing water to flow through the body 24 as can generally be seen in FIG. 9. In embodiments, a flow control element 26 (see FIG. 8, for example) is mounted in the body 24. In embodiments, the flow control element 26 is conical in shape and mounted in the base 24 such that, in an open position, the openings 24a of the body 24 are aligned with flow openings 26a formed in the flow control element 26 to allow water to flow through the openings 24a and 26a. The flow control element 26 is rotatable relative to the body 24 such that the flow openings 26a may be moved out of alignment with the openings 24a in the body to reduce flow of water. In embodiments, an outer dial 26c portion of the flow control element 26 and may be accessible from an exterior of the housing 10 such that the flow control element 26 may be adjusted from the exterior to adjust the flow of water to the nozzle. FIG. 10 illustrates the flow control element 26 mounted in the body 24 and positioned to align the openings 24a with the openings 26a, while FIG. 11 illustrates the ribs 24b aligned with the openings 26a to limit or shut the flow of water off.

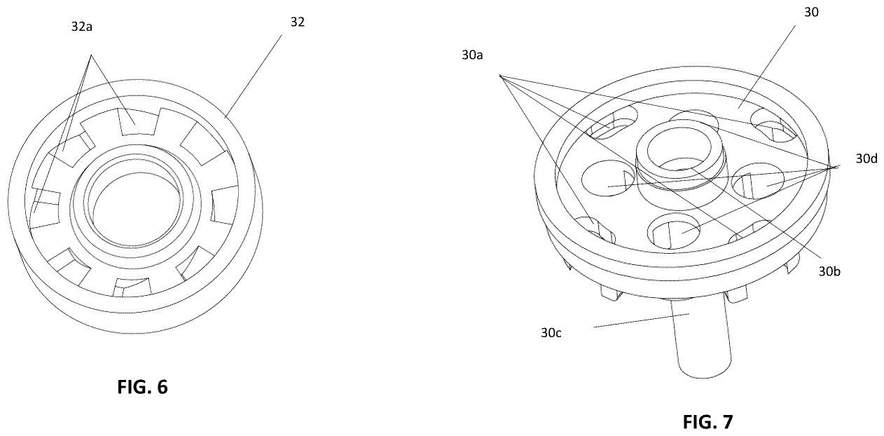

In embodiments, water flows through the body 24 and flow control element 26 to a base 30 of the nozzle housing 10 mounted above the flow control element 26. The base 30 includes alignment openings 30a configured to interact with the posts 24c extending upward from the body 24. The posts 24c are received in the openings 30a and retain the body 24 in place as the flow control element 26 is rotated relative thereto. A central opening 30b is formed in the top of the base 30 and a rod sleeve 30c extends downward therefrom and receives the rod 18 to allow movement of the rod relative to the body. A plurality of flow openings 30d are formed in the base 30 spaced around the central opening 30b through which water flows as can be seen in FIG. 7, for example. In embodiments, a flow director 32 is provided downstream of the base 30. In embodiments, the flow director 32 includes a plurality of flow slots 32a formed therethrough as can be seen in FIG. 6, for example. In embodiments, water flows through the openings 30d in the base 30 and into the slots 32a. In embodiments, the slots 32a are angled to direct water out of the flow director 32 in a helical pattern.

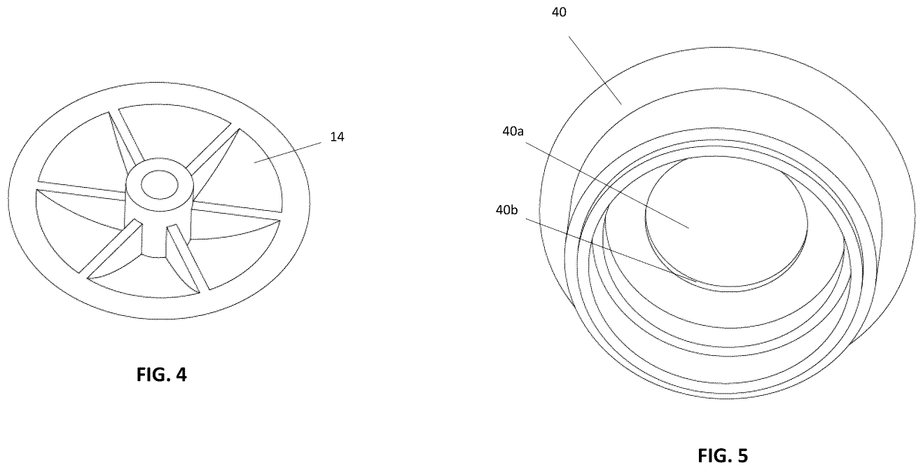

In embodiments, a deflector 40 is mounted above and downstream from the flow director 32 and the helical pattern of water is directed to the deflector 40. In embodiments, the water flows out of the slots 32a and deflects off the deflector 40 and out of the housing 10. In embodiments, the nozzle guard 14 is raised above the central opening 40a to allow the water to leave the housing 10. In embodiments, an edge 40b around the central opening 40a is beveled or angled to deflect water outward radially around the sprinkler. The bottom side of the deflector 40 is illustrated in FIG. 5.

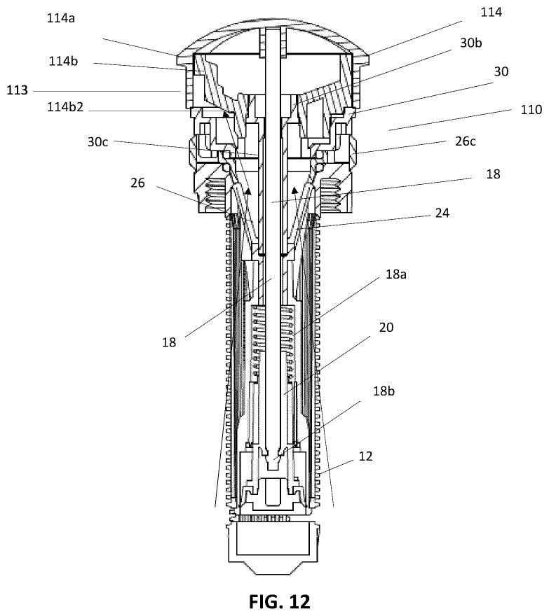

In embodiments, a sprinkler head nozzle assembly 110 in accordance with another embodiment of the present disclosure is illustrated in FIG. 12. In the assembly 110, the nozzle guard 114 is mounted on the rod 18 similar to the nozzle guard 14 discussed above with respect to FIGS. 1-3. In embodiments, the nozzle assembly 110 is similar to the assembly 10 discussed above but does not include the deflector 40 or the flow director 32. In embodiments, the sprinkler head nozzle assembly 110 may be mounted in the sprinkler base 30 similar to the assembly 10 discussed above.

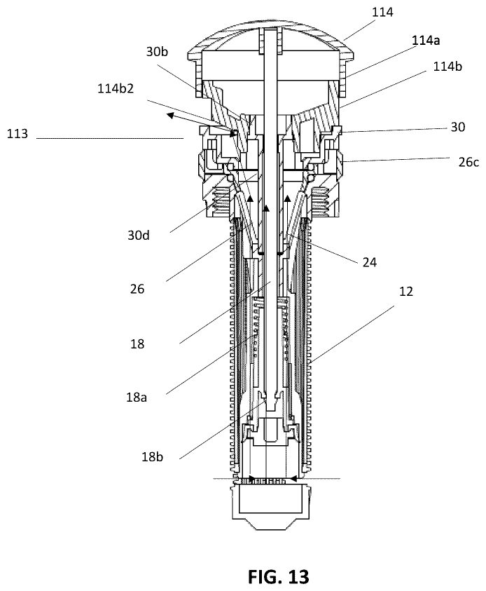

In embodiments, the nozzle guard 114 may be movably mounted on top of the assembly 110. In embodiments, the nozzle guard 114 is mounted on the rod 18 and is movable in the assembly 110 from a closed position shown in FIG. 12, where the nozzle guard 114 covers and protects the nozzle and prevents debris from entering. The rod 18 is biased into the closed position using the biasing element 18a, as noted above with respect to FIGS. 1-3, which may be a spring or any other suitable biasing element. In embodiments, the distal end of the rod 18 includes ridge 18b that extends radially outward to engage a movable member 20 that is biased into the closed position via the biasing element 18a. As water passes into the filter 12 as indicated in the arrows in FIG. 13, water pressure pushes up on the movable member 20 and pushes it upward against the biasing force of the biasing element 18a to raise the nozzle guard 114 as indicated in FIG. 13, for example.

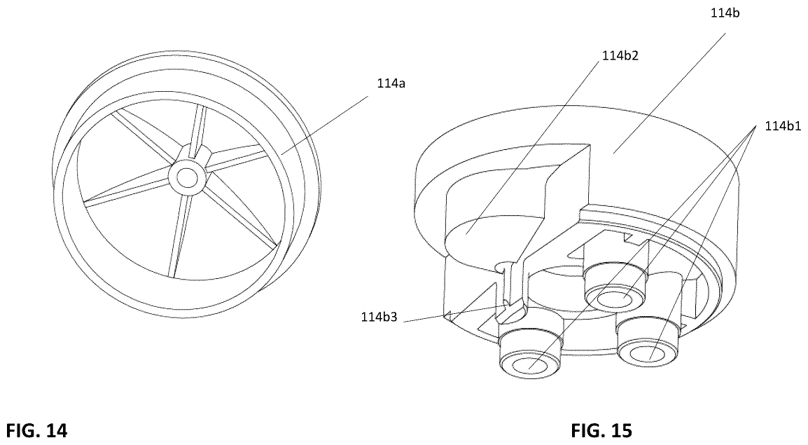

In embodiments, the nozzle guard 114 may include a top portion 114a that moves up and down with the rod 18 relative to a bottom portion 114b. In embodiments, as can be seen in FIG. 14, the top portion 114a is wide enough to extend across the diameter of the head 110 and beyond the periphery of the lower portion 114b. In embodiments, the bottom portion 114b is shaped to deflect water out a side of the assembly 110. In embodiments, the lower portion 114b includes three blocking tabs 114b1 configured to prevent water flow through three of the flow openings 30d, while a partial tab 114b3 allows for flow from the fourth flow opening to deflect off the deflector face 114b2 as can be seen in FIG. 15. The deflector face 114b2 deflects water out of the assembly 110. The base 30 includes alignment openings 30a configured to interact with the posts 24c extending upward from the body 24. The posts 24c are received in the openings 30a and retain the body 24 in place as the flow control element 26 is rotated relative thereto. Central opening 30b is formed in the top of the base 30 and a rod sleeve 30c extends downward therefrom and receives the rod 18 to allow movement of the rod relative to the body. A plurality of flow openings 30d are formed in the base 30 spaced around the central opening able through which water flows. As can be seen in FIG. 12, in a closed position, the nozzle guard is in a closed, lowered position to prevent debris from entering. In FIG. 13, the water flow into the assembly 110 raises the rod 18, which raises the top portion 114a of the nozzle guard 114 to allow water to flow out the side of the assembly as it is deflected off the deflector face 114b2.

In operation, water flows into the sprinkler head nozzle assembly 110 via the filter element 12 as indicated by the arrows in FIG. 13. In embodiments, the water flowing through the filter pushed the movable element 20 and rod 18 upward such that the top portion 114a rises. In embodiments, the water flows into the openings 24a in the body 24. In embodiments, the body 24 includes multiple openings 24a as noted above and the flow control element 26 is mounted in the body 24 and movable such that the flow ribs 26b may be moved into and out of the openings 24a to control the flow of water to the head 113. In embodiments, the water flows through the body 24 and the flow control element 26 and through the flow openings 30d. In embodiments, the ring 26c is accessible from the exterior to move the flow control element 26 relative to the body 24 and adjust the flow of water. The water then flows upward through the partially blocked flow opening 30d and deflects off the deflector face 114b2 of the lower portion 114b of the nozzle guard 114. In embodiments, the number blocking tabs 114b3 may be varied to provide for water coverage over a wider area.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly. cm What is claimed is:

1. A sprinkler head nozzle assembly comprises:
a body including at least a first opening configured to allow water to pass therethrough;
a flow control element mounted in the body to control a flow of water through the sprinkler head nozzle assembly;
a flow director positioned downstream of the flow control element, the flow director including at least one angled opening configured to direct water upward in a helical pattern;
a deflector positioned downstream of the flow director and including a central opening configured to direct water out of the sprinkler head nozzle assembly; and
a nozzle cover positioned downstream of the deflector and movable from a closed position in which it covers the central opening and an open position in which it is spaced from the central opening such that water passes out of the central opening.

2. The sprinkler head nozzle assembly of claim 1, further comprising a rod, movably mounted in the sprinkler head nozzle assembly, wherein the nozzle guard is attached to a top of the rod such that the rod moves the nozzle guard from the closed position to the open position.

3. The sprinkler head nozzle assembly of claim 2, further comprising a movable element mounted in the sprinkler head, wherein the movable element is biased in a lowered position and movable to a raised position, wherein the movable element is operably connected to the rod to move the rod from the closed position to the open position.

4. The sprinkler head nozzle assembly of claim 3, wherein the rod includes a ridge extending radially outward around the rod at a bottom thereof, wherein the ridge engages the movable element such that the rod moves up and down in the sprinkler head nozzle assembly with the movable element.

5. The sprinkler head nozzle assembly of claim 1, further comprising a filter provided upstream from the body and configured to provide water to the body.

6. The sprinkler head nozzle assembly of claim 1, wherein the flow control element includes at least a second opening and the flow control element is movable relative to the body to move at least the second opening into and out of alignment with at least the first opening to control flow of water.

7. The sprinkler head nozzle assembly of claim 6, wherein the body includes a plurality of first openings configured to allow water to pass through the body.

8. The sprinkler head nozzle assembly of claim 7, wherein the flow control element includes a plurality of second openings, wherein the flow control element is movable relative to the body to move the plurality of second openings into and out of alignment with the plurality of first openings to control flow of water.

9. The sprinkler head nozzle assembly of claim 1, wherein the flow director includes a plurality of angled openings configured to direct water upward in a helical pattern.

10. The sprinkler head nozzle assembly of claim 1, wherein a periphery of the central opening of the deflector includes a beveled edge configured to direct water out of the sprinkler head nozzle assembly.

11. A sprinkler head nozzle assembly comprises:
a body including at least a first opening configured to allow water from the filter to pass therethrough;
a flow control element mounted in the body to control a flow of water through the sprinkler head nozzle assembly;
a nozzle cover positioned downstream of the flow control element and including:
a bottom portion including a deflector surface configured to direct water out a side of the sprinkler head nozzle assembly; and
a top portion movable relative to the bottom portion from a lowered position in which the top portion prevents debris from entering and a raised position in which water exits the sprinkler head nozzle assembly.

12. The sprinkler head nozzle assembly of claim 11, further comprising a rod, movably mounted in the sprinkler head nozzle assembly, wherein the nozzle guard is attached to a top of the rod such that the rod moves the nozzle guard from the lowered position to the raised position.

13. The sprinkler head nozzle assembly of claim 12, further comprising a movable element mounted in the sprinkler head nozzle assembly, wherein the movable element is biased in a lowered position and movable to a raised position, wherein the movable element is operably connected to the rod to move the rod from the lower position to the raised position.

14. The sprinkler head nozzle assembly of claim 13, wherein the rod includes a ridge extending radially outward around the rod at a bottom thereof, wherein the ridge engages the movable element such that the rod moves up and down in the sprinkler head nozzle assembly with the movable element.

15. The sprinkler head nozzle assembly of claim 11, further comprising a filter provided upstream from the body and configured to provide water to the body.

16. The sprinkler head nozzle assembly of claim 11, wherein the flow control element includes at least a second opening and the flow control element is movable relative to the body to move at least the second opening into and out of alignment with at least the first opening to control flow of water.

17. The sprinkler head nozzle assembly of claim 11, wherein the body includes a plurality of first openings configured to allow water to pass through the body.

18. The sprinkler head nozzle assembly of claim 17, wherein the flow control element includes a plurality of second openings, wherein the flow control element is movable relative to the body to move the plurality of second openings into and out of alignment with the plurality of first openings to control flow of water.

19. The sprinkler head nozzle assembly of claim 11, wherein the lower portion includes a plurality of blocking tabs configured to partially block water flow.
